(19) United States
(12) Patent Application Publication
(10) Pub. No.: US 2026/0337006 A1
(43) Pub. Date: Oct. 29, 2026

(54) NOZZLE HEAD AND TANK VALVE DEVICE COMPRISING SAME

(71) Applicant: KAWASAKI JUKOGYO KABUSHIKI KAISHA, Kobe-shi, Hyogo (JP)

(72) Inventors: Masayoshi OKAMOTO, Kobe-shi (JP); Tsutomu TOMITA, Kobe-shi (JP); Makoto NINOMIYA, Kobe-shi (JP); Ryo MIYOSHI, Kobe-shi (JP)

(21) Appl. No.: 19/162,898

(22) PCT Filed: Feb. 15, 2024
(86) PCT No.: PCT/JP2024/005227

§ 371 Date: Sep. 5, 2025

(30) Foreign Application Priority Data
Mar. 10, 2023 (JP) 2023-038122

(51) Int. Cl. B67D 7/76

(52) U.S. Cl. CPC B67D 7/76; B67D 2210/0001

(57) ABSTRACT

This nozzle head of a tank valve device to be attached to a port of a tank includes: a nozzle body fastened to a valve block of the tank valve device by a fastening member and including an outlet passage through which a fluid flows out of the tank; a filter fitting in an entry portion of the outlet passage; and a lid member provided on the entry portion to cover a peripheral edge portion of the filter and including a through-hole corresponding to the outlet passage. The lid member is co-fastened to the valve block by the fastening member together with the nozzle body.

### TECHNICAL FIELD

The present disclosure relates to a nozzle head of a tank valve device to be attached to a port of a tank, and to the tank valve device including the nozzle head.

### BACKGROUND ART

The tank valve disclosed in Patent Literature (PTL 1) is known as a tank valve device to be mounted at a port of a tank. The tank valve disclosed in PTL 1 includes a jet flow deflection piece to be attached to a valve body. A filter is disposed inside the jet flow deflection piece.

### CITATION LIST

### Patent Literature

PTL 1: Japanese Laid-Open Patent Application Publication No. 2013-64440

### SUMMARY OF INVENTION

### Technical Problem

In the tank valve disclosed in PTL 1, the filter is attached to the jet flow deflection piece (equivalent to a nozzle body of a nozzle head) by a C ring. When such a structure for assembly is applied, a gap is formed between the filter and the C ring. Therefore, the filter moves, in other words, the filter wobbles, during use. In view of this, there is a demand for a simple structure for assembly in which the filter can be more securely attached to the nozzle body.

Thus, an object of the present disclosure is to provide a nozzle head and a tank valve device with a simple structure for assembly in which a filter to be provided at an outlet can be securely attached to a nozzle body.

### Solution to Problem

A nozzle head according to the present disclosure is included in a tank valve device to be attached to a port of a tank and includes: a nozzle body fastened to a valve block of the tank valve device by a fastening member and including an outlet passage through which a fluid flows out of the tank; a filter fitting in an entry portion of the outlet passage; and a lid member provided on the entry portion to cover a peripheral edge portion of the filter and including a through-hole corresponding to the outlet passage. The lid member is co-fastened to the valve block by the fastening member together with the nozzle body.

According to the present disclosure, the lid member attached to the entry portion to cover the peripheral edge portion of the filter is co-fastened to the valve block by the fastening member together with the nozzle body. This means that the filter is attached to the nozzle body as a result of the lid member covering the filter and being co-fastened by the fastening member. Therefore, with a simple structure for assembly, the filter provided in the outlet passage can be securely attached to the nozzle body.

A tank valve device according to the present disclosure includes: the nozzle head described above; and the valve block that is attached to the port of the tank in the tank valve device and to which the nozzle head is fixed by the fastening member.

According to the present disclosure, functions such as those described above can be realized.

### ADVANTAGEOUS EFFECTS OF INVENTION

According to the present disclosure, a filter to be provided at an outlet can be securely attached to a nozzle body with a simple structure for assembly.

The above object, other objects, features, and advantages of the present disclosure will be made clear by the following detailed explanation of preferred embodiments with reference to the attached drawings.

### BRIEF DESCRIPTION OF DRAWINGS

FIG. 1 is a front view illustrating a tank valve device according to Embodiment 1 of the present disclosure.

FIG. 2 is a perspective view illustrating a nozzle head of the tank valve device of FIG. 1.

FIG. 3 is a bottom view of the nozzle head of FIG. 2 viewed from the bottom.

FIG. 4 is a cross-sectional view of the nozzle head of FIG. 3 taken along cut line IV-IV.

FIG. 5 is a cross-sectional view of the nozzle head of FIG. 3 taken along cut line V-V.

### DESCRIPTION OF EMBODIMENTS

Hereinafter, a tank valve device 1 according to an embodiment of the present disclosure will be described with reference to the aforementioned drawings. Note that the concept of directions mentioned in the following description is used for the sake of explanation; the orientations, etc., of elements according to the present disclosure are not limited to these directions. The tank valve device 1 described below is merely one embodiment of the present disclosure. Thus, the present disclosure is not limited to the following embodiments and may be subject to addition, deletion, and alteration within the scope of the essence of the present disclosure.

### Tank Valve Device

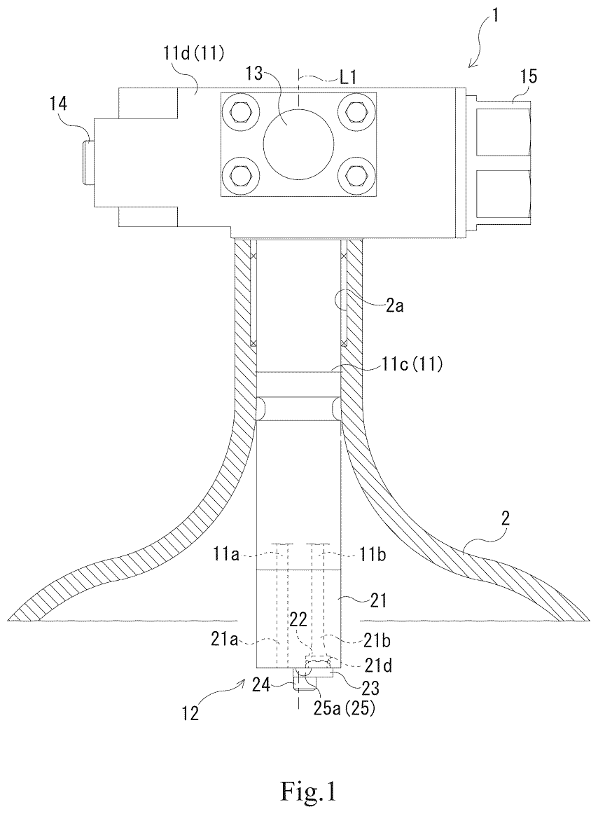

A tank 2 illustrated in FIG. 1 is capable of storing a fluid. In the present embodiment, the fluid is a gas. The tank valve device 1 is provided on the tank 2. The tank valve device 1 according to Embodiment 1 includes a valve block 11, a nozzle head 12, and various valves 13, 14, as illustrated in FIG. 1. The tank valve device 1 seals a port 2a of the tank 2. As a result, the tank 2 is hermetically closed. The tank valve device 1 is, for example, a tank valve device of the on-tank valve type. The tank valve device 1 is capable of filling the tank 2 with the fluid and delivering the fluid from the tank 2.

### [Valve Block]

The valve block 11 is a member that extends in a predetermined direction. The predetermined direction is along a predetermined axis L1, for example. The valve block 11 is attached to the port 2a of the tank 2. In the valve block 11, a block-end filling passage 11a and a block-end drainage passage 11b are formed. The fluid for filling the tank 2 (for example, a gas such as hydrogen) flows through the block-end filling passage 11a, and the fluid to be drained from the tank 2 flows through the block-end drainage passage 11b.

More specifically, in the valve block 11, a plug part 11c, which is a part of the valve block 11, is inserted through the port 2a of the tank 2, as illustrated in FIG. 1. The plug part 11c is formed in the shape of a circular column and seals the port 2a. A block body 11d, which is a part of the valve block 11, projects outward through the port 2a. Various valves 13 to 15 are provided on the block body 11d.

### [Nozzle Head]

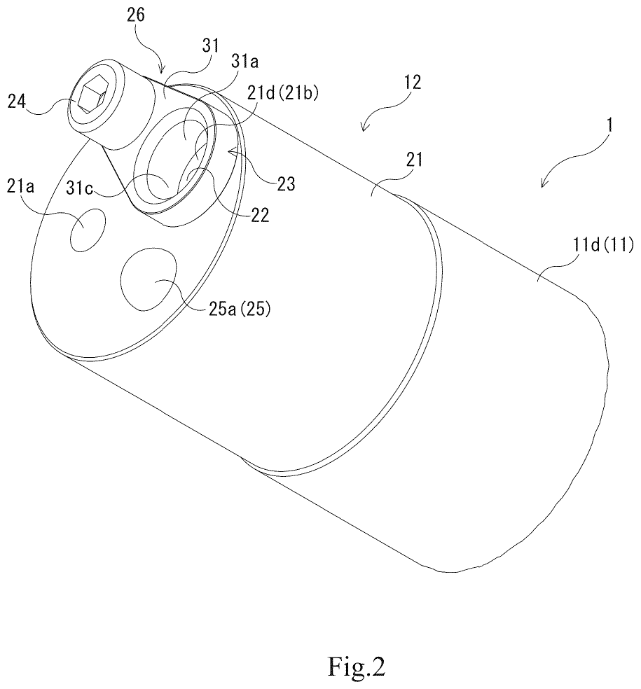

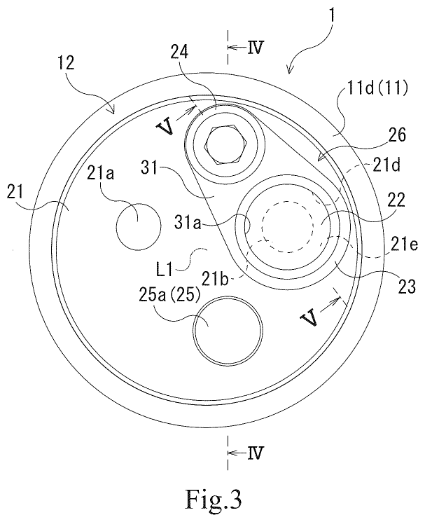

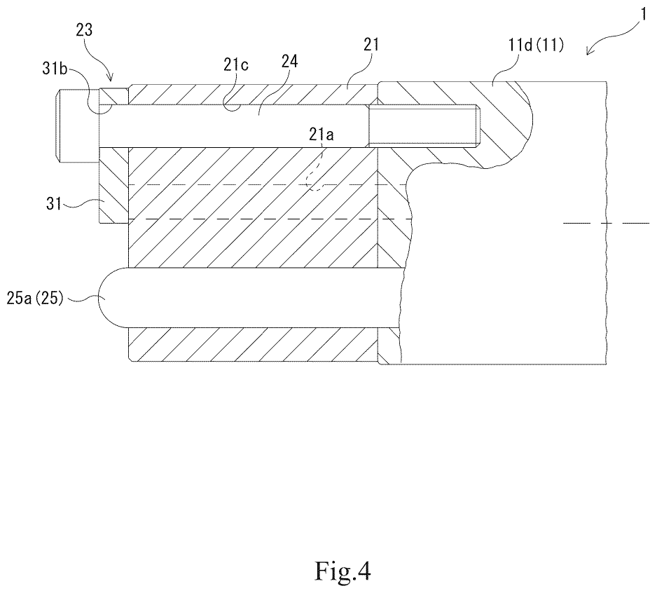

The nozzle head 12 includes a nozzle body 21, a filter 22, a lid member 23, and a fastening member 24, as illustrated in FIG. 2 and FIG. 3. Furthermore, the nozzle head 12 includes a temperature sensor 25. The nozzle head 12 is fixed to the valve block 11 by the fastening member 24, as illustrated in FIG. 4. More specifically, the nozzle head 12 is formed in the shape of a circular column. The nozzle head 12 is fastened to a leading end portion, namely, the plug part 11, of the valve block 11, by the fastening member 24. Therefore, the nozzle head 12 is positioned at the leading end of the tank valve device 1 and disposed inside the tank 2. The nozzle head 12 blows out the fluid supplied to the tank valve device 1 (for example, a gas such as hydrogen), to fill the tank 2 with the gas, and also causes the gas to flow out of the tank 2.

### Nozzle Body

The nozzle body 21 is fastened to the valve block 11 by the fastening member 24. More specifically, the nozzle body 21 is formed in the shape of a circular column. The nozzle body 21 is fastened to the plug part 11c so as to butt against one axial end surface of the plug part 11c. Furthermore, the nozzle body 21 includes a nozzle-end filling passage 21a and a nozzle-end drainage passage 21b, as illustrated in FIG. 3. Furthermore, the nozzle body 21 includes a fastening member insertion hole 21c.

The nozzle-end filling passage 21a, which is an example of the inlet passage, is a passage through which the fluid for filling the tank 2 flows. The nozzle-end filling passage 21a is connected to the block-end filling passage 11a of the valve block 11 (refer to FIG. 11) and causes the fluid for filling the tank 2 to be blown out thereto. In the present embodiment, the nozzle-end filling passage 21a extends in the axial direction (refer to FIG. 3). The nozzle-end filling passage 21a is open on one axial end surface of the nozzle body 21. Note that the nozzle-end filling passage 21a does not necessarily need to be formed in a straight line in the axial direction and may be curved or bent, for example.

The nozzle-end drainage passage 21b, which is an example of the outlet passage, is a passage through which the fluid to be drained from the tank 2 flows. The nozzle-end drainage passage 21b is connected to the block-end drainage passage 11b of the valve block 11 (refer to FIG. 1) and brings the fluid in the tank 2 to the block-end drainage passage 11b. In the present embodiment, the nozzle-end drainage passage 21b extends in the axial direction. The nozzle-end drainage passage 21b is open on the one axial end surface of the nozzle body 21. An entry portion 21d, which is an opening portion of the nozzle-end drainage passage 21b, is formed to be larger in diameter than the rest. Thus, the entry portion 21d is formed in the shape of steps. Specifically, the entry portion 21d includes a step portion 21e.

The fastening member insertion hole 21c is a hole designed to allow insertion of the fastening member 24. In the present embodiment, the fastening member insertion hole 21c extends in the axial direction. The fastening member insertion hole 21c is open on the one axial end surface of the nozzle body 21. The opening of the fastening member insertion hole 21c is positioned so that the axis L1 is included in a triangle with vertices at the center of the opening of the fastening member insertion hole 21c, the center of the opening of the nozzle-end filling passage 21a, and the center of the opening of the nozzle-end drainage passage 21b in a bottom view seen from one side in the axial direction. The fastening member insertion hole 21c is located opposite to a temperature sensor 25, which will to be described later, with the axis L1 therebetween in the bottom view.

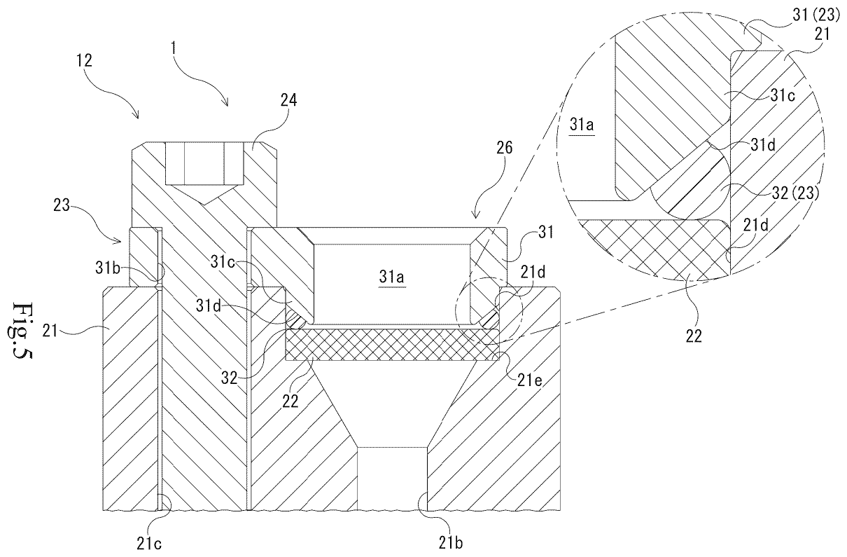

The filter 22 fits in the entry portion 21d of the nozzle-end drainage passage 21b, as illustrated in FIG. 5. The filter 22 captures contaminants and the like included in the fluid that is drained from the tank 2 to the nozzle-end drainage passage 21b. More specifically, the filter 22 is a coin-shaped filter and formed in the shape of a disc. In the present embodiment, the filter 22 has the same outer diameter as the bore diameter of the entry portion 21d and is formed to be smaller in thickness than the depth of the entry portion 21d. The filter 22 fits in the entry portion 21d so that the outer peripheral edge of the filter 22 is supported on the step portion 21e of the entry portion 21d.

The lid member 23 includes a through-hole 31a, as illustrated in FIG. 3. The lid member 23 is provided on the entry portion 21d by covering the peripheral edge portion of the filter 22. As a result, the nozzle-end drainage passage 21b is connected to an external area, specifically, the inside of the tank 2, via the through-hole 31a. The lid member 23 is co-fastened to the valve block 11 (more specifically, the plug part 11c) by the fastening member 24 together with the nozzle body 21. This allows the lid member 23 to sandwich and hold the peripheral edge portion of the filter 22 against the step portion 21e and hold the filter 22 on the entry portion 21d. Note that the lid member 23 constitutes the filter structure 26 together with the filter 22 in the present embodiment.

More specifically, the lid member 23 includes a lid body 31 and a pressing body 32. The lid body 31 is provided on the entry portion 21d by covering the peripheral edge portion of the filter 22. The lid body 31 is co-fastened to the plug part 11c together with the nozzle body 21. In the present embodiment, the lid body 31 is formed as a plate in the shape of an oval (for example, the shape of a rounded corner trapezoid with semicircular opposite ends) as viewed from the bottom. The through-hole 31a is formed in a portion of the lid body 31 that is located at one longitudinal end thereof, and a fastening member hole 31b is formed in a portion of the lid body 31 that is located at the other longitudinal end thereof. The through-hole 31a and the fastening member hole 31b penetrate the lid body 31 in the thickness direction of the lid body 31 (that is the axial direction in the present embodiment). The through-hole 31 a and the fastening member hole 31b are formed concentrically with the semicircular opposite ends in the present embodiment.

Furthermore, the lid body 31 includes a projecting portion 31c, as illustrated in FIG. 5. The projecting portion 31c is formed around the through-hole 31a of the lid body 31 so as to project on the other side in the axial direction. The projecting portion 31c is formed in the shape of a circular ring. The projecting portion 31c fits in the entry portion 21d of the nozzle-end drainage passage 21b. The lid body 31 is disposed so that the leading end thereof is spaced apart from the filter 22 in the axial direction.

Furthermore, the lid body 31 includes an attachment surface 31d in the shape of a ring. The attachment surface 31d is a ring-shaped surface facing the filter 22. More specifically, the attachment surface 31d is formed at the opening end of the through-hole 31a in the lid body 31. In the present embodiment, the attachment surface 31d is formed on the outer peripheral edge of the leading end of the projecting portion 31c. The attachment surface 31d is formed tapered such that the external shape thereof expands with the distance from the filter 22. In other words, the attachment surface 31d is formed tapered with a diameter increasing as the position thereof is farther on the one side in the axial direction. The attachment surface 31d is formed by C-chamfering the outer peripheral edge of the leading end of the projecting portion 31c.

The pressing body 32 presses the outer peripheral edge portion of the filter 22 against the entry portion 21d. More specifically, the pressing body 32 is a member formed of an elastic body of a synthetic rubber or the like. The pressing body 32 is formed in the shape of a circular ring. In the present embodiment, the pressing body 32 is a ring-shaped sealing member and is, for example, an O-ring. The pressing body 32 is attached to the attachment surface 31d. In the present embodiment, the pressing body 32 is provided exteriorly on the attachment surface 31d. Furthermore, the pressing body 32 projects from the attachment surface 31d toward the filter 22 and is crushed when pressed against the filter 22. Therefore, the outer peripheral edge portion of the filter 22 is pressed against the step portion 21e of the entry portion 21d by the pressing body 32. Thus, the pressing body 32 sandwiches and holds the filter 22 against the step portion 21e and holds the filter 22 within the entry portion 21d.

The fastening member 24 co-fastens the nozzle body 21 to the valve block 11 together with the lid member 23, as illustrated in FIG. 4. More specifically, the fastening member 24 is a bolt and inserted through the fastening member insertion hole 21c. Furthermore, the fastening member 24 has a leading end portion thereof screwed into the valve block 11 (more specifically, the plug part 11c). Moreover, by causing a head portion of the fastening member 24 to abut the lid member 23, the fastening member 24 sandwiches and holds the nozzle body 21 and the lid member 23 against the valve block 11.

The temperature sensor 25 measures the temperature of the fluid in the tank 2. The temperature sensor 25 is formed in the shape of a rod. The temperature sensor 25 is disposed penetrating the nozzle body 21 in the axial direction. The temperature sensor 25 has a leading end portion thereof projecting from the nozzle body 21 and measures the internal temperature of the tank 2 by a sensing portion 25a on the leading end portion of the temperature sensor 25.

In the tank valve device 1, when a fluid is supplied thereto through a filling port not illustrated in the drawings, the fluid is brought into the tank 2 through the block-end filling passage 11a and the nozzle-end filling passage 21a, and thus the tank 2 is filled with the fluid. Furthermore, in the tank valve device 1, the fluid in the tank 2 passes through the nozzle-end drainage passage 21b and then the block-end drainage passage 11b and is drained from the tank valve device 1. At this time, the filter 22 captures contaminants contained in the fluid to be drained. This makes it possible to further reduce instances of the drained fluid containing contaminants.

In the nozzle head 12 according to the present embodiment, the lid member 23 attached to the entry portion 21b by covering the peripheral edge portion of the filter 22 is co-fastened to the valve block 11 by the fastening member 24 together with the nozzle body 21. This means that the filter 22 is attached to the nozzle body 21 as a result of the lid member 23 covering the filter 22 and being co-fastened by the fastening member 24. Therefore, with a simple structure for assembly, the filter 22 provided in the nozzle-end drainage passage 21b can be securely attached to the nozzle body 21.

Furthermore, in the nozzle head 12 according to the present embodiment, the filter 22 is a coin-shaped filter and fits in the entry portion 21d so that the outer peripheral edge of the filter 22 is supported on the step portion 21e of the entry portion 21d. Therefore, it is possible to position the filter 22 on the entry portion 21d by fitting the filter 22 into the entry portion 21d. Thus, it is easy to position the filter 22.

Furthermore, in the nozzle head 12 according to the present embodiment, the pressing body 32, which presses the outer peripheral edge portion of the filter 22 against the entry portion 21d and sandwiches and holds the filter 22 therebetween, is formed of an elastic member. Therefore, the outer peripheral edge portion of the filter 22 can be kept from being squashed and damaged when the filter 22 is sandwiched and held.

Furthermore, in the nozzle head 12 according to the present embodiment, the attachment surface 31d to which the pressing body 32 is attached is formed tapered. Therefore, the pressing body 32 can be pressed against the filter 22 without gaps, and the pressing body 32 can be kept from falling off through the through-hole 31a, for example, even when the pressing body 32 is reduced in diameter.

Furthermore, in the nozzle head 12 according to the present embodiment, the nozzle-end filling passage 21a through which the fluid flows into the tank 2 is formed in the nozzle body 21. This means that the nozzle body 21 includes the separate channels 21a, 21b through which the fluid flows into and out of the tank 25. Therefore, contaminants and the like captured when the fluid flows into the tank 2 via the filter 22 can be kept from returning to the nozzle-end drainage passage 21b when the fluid flows out of the tank 2.

In the tank valve device 1 according to the present embodiment, functions such as those described above can be realized.

### Other Embodiments

In the tank valve device 1, the nozzle head 12 is formed in the shape of a circular column in the bottom view, but may be formed in the shape of a semicircular or quadrant column in the bottom view. When the nozzle head is a semicircular column, the temperature sensor 25 is disposed outside the nozzle head, for example. Furthermore, the attachment surface 31d of the lid member 23 does not necessarily need to be tapered. In this case, a step portion or a groove may be formed at the opening end of the projecting portion 31c, for example, to lock the pressing body 32 so that the pressing body 32 is not pulled into the through-hole 31a. Furthermore, the pressing body 32 does not necessarily need to be in abutment with the filter 22 and may also be omitted. Similarly, the temperature sensor 25 does not necessarily need to be provided and the shape and the position thereof are not limited to those described above.

### Exemplary Embodiments

A nozzle head according to the first aspect is a nozzle head of a tank valve device to be attached to a port of a tank and includes: a nozzle body fastened to a valve block of the tank valve device by a fastening member and including an outlet passage through which a fluid flows out of the tank; a filter fitting in an entry portion of the outlet passage; and a lid member provided on the entry portion to cover a peripheral edge portion of the filter and including a through-hole corresponding to the outlet passage. The lid member is co-fastened to the valve block by the fastening member together with the nozzle body.

According to this aspect, the lid member attached to the entry portion to cover the peripheral edge portion of the filter is co-fastened to the valve block by the fastening member together with the nozzle body. This means that the filter is attached to the nozzle body as a result of the lid member covering the filter and being co-fastened by the fastening member. Therefore, with a simple structure for assembly, the filter provided in the outlet passage can be securely attached to the nozzle body.

In a nozzle head according to the second aspect, in the nozzle head according to the first aspect, the entry portion includes a step portion, and the filter is a coin-shaped filter, has an outer peripheral edge supported on the step portion, and fits in the entry portion.

According to this aspect, the filter is a coin-shaped filter and fits in the entry portion so that the outer peripheral edge of the filter is supported on the step portion of the entry portion. Therefore, it is possible to position the filter on the entry portion by fitting the filter into the entry portion; thus, it is easy to position the filter.

In a nozzle head according to the third aspect, in the nozzle head according to the second aspect, the lid member includes: a lid body covering the peripheral edge portion of the filter and being co-fastened to the valve block together with the nozzle body; and a pressing body provided between the lid body and the filter and pressing an outer peripheral edge portion of the filter against the entry portion, and the pressing body is formed of an elastic body.

According to this aspect, the pressing body that presses the outer peripheral edge portion of the filter against the entry portion and sandwiches and holds the filter therebetween is formed of an elastic member. Therefore, the outer peripheral edge portion of the filter can be kept from being squashed and damaged when the filter is sandwiched and held.

In a nozzle head according to a fourth aspect, in the nozzle head according to the third aspect, the lid member includes an attachment surface facing the filter and being in the shape of a ring, the pressing body is a ring-shaped elastic body and is attached to the attachment surface of the lid member, and the attachment surface is formed tapered such that an external shape thereof expands with a distance from the filter.

According to this aspect, the attachment surface to which the pressing body is attached is formed tapered. Therefore, while ensuring that the pressing body applies a sufficient pressing load in pressing the filter, it is possible to keep the pressing body from falling off through the through-hole, for example, even when the pressing body is reduced in diameter.

In a nozzle head according to a fifth aspect, in the nozzle head according to any one of the first to fourth aspects, the nozzle body includes an inlet passage through which the fluid flows into the tank.

According to this aspect, the nozzle body includes the inlet passage through which the fluid flows into the tank. This means that the nozzle body includes separate channels through which the fluid flows into and out of the tank. Therefore, contaminants and the like captured when the fluid flows into the tank via the filter can be kept from returning to the outlet passage when the fluid flows out of the tank.

A tank valve device according to the sixth aspect includes: the nozzle head according to any one of the first to fifth aspects; and the valve block that is attached to the port of the tank in the tank valve device and to which the nozzle head is fixed by the fastening member.

According to this aspect, functions such as those described above can be realized.

From the foregoing description, many modifications and other embodiments of the present disclosure would be obvious to a person having ordinary skill in the art. Therefore, the foregoing description should be interpreted only as an example and is provided for the purpose of teaching the best mode for carrying out the present disclosure to a person having ordinary skill in the art. Substantial changes in details of the structures and/or functions of the present disclosure are possible within the spirit of the present disclosure.

### REFERENCE CHARACTER LIST

1 tank valve device
2 tank
2a port
11 valve block
12 nozzle head
21 nozzle body
21a nozzle-end filling passage (inlet passage)
21b nozzle-end drainage passage (outlet passage)
21d entry portion
21e step portion
22 filter
23 lid member
24 fastening member
31 lid body
31a through-hole
31d attachment surface
32 pressing body

1. A nozzle head of a tank valve device to be attached to a port of a tank, the nozzle head comprising:
a nozzle body fastened to a valve block of the tank valve device by a fastening member and including an outlet passage through which a fluid flows out of the tank;
a filter fitting in an entry portion of the outlet passage; and
a lid member provided on the entry portion to cover a peripheral edge portion of the filter and including a through-hole corresponding to the outlet passage, wherein:
the lid member is co-fastened to the valve block by the fastening member together with the nozzle body.

2. The nozzle head according to claim 1, wherein:
the entry portion includes a step portion; and
the filter is a coin-shaped filter, has an outer peripheral edge supported on the step portion, and fits in the entry portion.

3. The nozzle head according to claim 2, wherein:
the lid member includes:
a lid body covering the peripheral edge portion of the filter and being co-fastened to the valve block together with the nozzle body; and
a pressing body provided between the lid body and the filter and pressing an outer peripheral edge portion of the filter against the entry portion, wherein:
the pressing body is formed of an elastic body.

4. The nozzle head according to claim 3, wherein:
the lid member includes an attachment surface facing the filter and being in the shape of a ring;
the pressing body is a ring-shaped elastic body and is attached to the attachment surface of the lid member; and
the attachment surface is formed tapered such that an external shape thereof expands with a distance from the filter.

5. The nozzle head according to claim 1, wherein:
the nozzle body includes an inlet passage through which the fluid flows into the tank.

6. A tank valve device comprising:
the nozzle head according to claim 1; and
the valve block that is attached to the port of the tank in the tank valve device and to which the nozzle head is fixed by the fastening member.
